(19) United States
(12) Patent Application Publication
(10) Pub. No.: US 2025/0377160 A1
(43) Pub. Date: Dec. 11, 2025

(54) DRYING SYSTEM FOR SEMI-DRY PTFE-BASED ELECTRODE MANUFACTURING

(71) Applicant: GM Global Technology Operations LLC, Detroit, MI (US)

(72) Inventors: Dewen Kong, Shanghai (CN); Meiyuan Wu, Shanghai (CN); Haijing Liu, Shanghai (CN)

(21) Appl. No.: 18/746,552

(22) Filed: Jun. 18, 2024

(30) Foreign Application Priority Data
Jun. 11, 2024 (CN) 202410748498.3

(51) Int. Cl. F26B 3/04; F26B 3/28; F26B 13/08; F26B 25/00; H01M 4/04; H01M 4/62

(52) U.S. Cl. CPC F26B 3/04; F26B 3/283; F26B 13/08; F26B 25/006; H01M 4/0471; H01M 4/623

(57) ABSTRACT

A system for drying polytetrafluoroethylene (PTFE) based semi-dry electrode film includes a heating chamber including an inlet adapted to receive a PTFE-based semi-dry electrode film into the heating chamber, an outlet adapted to allow the PTFE-based semi-dry electrode film to exit the heating chamber, a plurality of rollers positioned within the heating chamber and adapted to support the PTFE-based semi-dry electrode film and guide the PTFE-based semi-dry electrode film along a serpentine path through the heating chamber between the inlet and the outlet as the PTFE-based semi-dry electrode film is pulled through the heating chamber, and at least one heating element adapted to heat an interior of the heating chamber, wherein, the heating chamber is adapted to remove, by evaporation, at least a portion of solvent that is present within the PTFE-based semi-dry electrode film that enters the heating chamber.

### INTRODUCTION

The present invention relates generally to a drying system for polytetrafluoroethylene (PTFE) based semi-dry electrode manufacturing.

### BACKGROUND OF THE INVENTION

The development of Lithium-ion battery (LIB) technology is one of the most promising energy storage technologies due to its lightweight and well-established chemistry. Traditionally, LIB battery electrodes are manufactured by a wet slurry process wherein active and additive powders are mixed with toxic organic solvents. Such solvents are toxic to the environment and causes severe health hazards to humans. Additionally, the energy and space needed for electrode drying and solvent recovery forms a large part of the electrode manufacturing cost. Dry and semi-dry electrode fabrication avoids the use of conventional toxic solvents, or at least reduces the amount of solvent used, by using PTFE as a fibrillation polymer. However, semi-dry PTFE-based electrode manufacturing still requires drying, and methods used to dry electrodes manufactured with a slurry process have the disadvantages discussed above.

Thus, while current systems and methods of electrode drying achieve their intended purpose, there is a need for a new and improved system and method for drying PTFE-based semi-dry electrode film during manufacturing.

### SUMMARY

According to several aspects of the present disclosure, a system for drying polytetrafluoroethylene (PTFE) based semi-dry electrode film includes a heating chamber including an inlet adapted to receive a PTFE-based semi-dry electrode film into the heating chamber, an outlet adapted to allow the PTFE-based semi-dry electrode film to exit the heating chamber, a plurality of rollers positioned within the heating chamber and adapted to support the PTFE-based semi-dry electrode film and guide the PTFE-based semi-dry electrode film along a serpentine path through the heating chamber between the inlet and the outlet as the PTFE-based semi-dry electrode film is pulled through the heating chamber, and at least one heating element adapted to heat an interior of the heating chamber, wherein, the heating chamber is adapted to remove, by evaporation, at least a portion of solvent that is present within the PTFE-based semi-dry electrode film that enters the heating chamber.

According to another aspect, the plurality of rollers are arranged within the heating chamber and adapted to guide the PTFE-based semi-dry electrode film along a horizontal serpentine pattern through the heating chamber, wherein a primary direction of travel of the PTFE-based semi-dry electrode film is horizontal, the plurality of rollers within the heating chamber including a plurality of horizontal support rollers adapted to support the PTFE-based semi-dry electrode film for horizontal movement across the heating chamber, and a plurality of horizontal transition rollers adapted to re-direct the horizontal direction of travel of the PTFE-based semi-dry electrode film.

According to another aspect, the plurality of rollers are arranged within the heating chamber and adapted to guide the PTFE-based semi-dry electrode film along a vertical serpentine pattern through the heating chamber, wherein a primary direction of travel of the PTFE-based semi-dry electrode film is vertical, the plurality of rollers within the heating chamber including a plurality of vertical support rollers adapted to support the PTFE-based semi-dry electrode film for vertical movement across the heating chamber, and a plurality of vertical transition rollers adapted to re-direct the vertical direction of travel of the PTFE-based semi-dry electrode film.

According to another aspect, the system further includes a solvent recovery system adapted to collect solvent that has been evaporated from the PTFE-based semi-dry electrode film as the PTFE-based semi-dry electrode film moves through the heating chamber.

According to another aspect, the at least one heating element is adapted to maintain a temperature within the heating chamber of between about one-hundred degrees Celsius and about two-hundred degrees Celsius.

According to another aspect, the heating element is adapted to at least one of heat the interior of the heating chamber using one of forced convention or natural convection, heat the interior of the heating chamber with forced air, and heat the interior of the heating chamber using infrared radiation.

According to another aspect, the system further includes a supply roll adapted to support a length of PTFE-based semi-dry electrode film thereon, the supply roll positioned in proximity to the inlet of the heating chamber, and a collector roll adapted to pull the PTFE-based semi-dry electrode film through the heating chamber from the supply roll and to collect the dried PTFE-based semi-dry electrode film exiting the heating chamber.

According to another aspect, the collector roll is adapted to pull the PTFE-based semi-dry electrode film through the heating chamber at a rate of between about fifteen meters per minute and about twenty-five meters per minute.

According to another aspect, the system further includes a substrate supply roll adapted to support a length of a substate film thereon, the substrate supply roll positioned in proximity to the inlet of the heating chamber, and a substrate collector roll adapted to collect the substrate film exiting the heating chamber, wherein, the system is adapted to position the PTFE-based semi-dry electrode film from the supply roll onto the substrate film from the substrate supply roll prior to entering the heating chamber through the inlet, the substrate film adapted to provide tension support as the PTFE-based semi-dry electrode film and the substrate film are pulled through the heating chamber at speeds of about eighty meters per minute, and separate the PTFE-based semi-dry electrode film from the substate film after the PTFE-based semi-dry electrode film and the substrate film exit the heating chamber, wherein, the PTFE-based semi-dry electrode film is collected on the collector roll and the substrate film is collected on the substrate collector roll.

According to another aspect, the substrate film comprises one of polyethylene terephthalate (PET), stainless steel mesh, copper mesh, or aluminum mesh.

According to another aspect, the heating chamber has a dimension, measured along the primary direction of travel of the PTFE-based semi-dry electrode film, that is between about five meters and about 7 meters, wherein, the serpentine path through the heating chamber has a length that is about ten times the dimension of the heating chamber measured along the primary direction of travel of the PTFE-based semi-dry electrode film.

According to several aspects of the present disclosure, a method for drying polytetrafluoroethylene (PTFE) based semi-dry electrode film includes feeding a PTFE-based semi-dry electrode film through an inlet of a heating chamber, heating an interior of the heating chamber with at least one heating element, supporting the PTFE-based semi-dry electrode film and guiding the PTFE-based semi-dry electrode film along a serpentine path through the heating chamber with a plurality of rollers positioned within the heating chamber between the inlet and an outlet as the PTFE-based semi-dry electrode film is pulled through the heating chamber, removing, by evaporation, at least a portion of solvent that is present within the PTFE-based semi-dry electrode film that enters the heating chamber, and removing the PTFE-based semi-dry electrode film from the heating chamber through the outlet.

According to another aspect, the supporting the PTFE-based semi-dry electrode film and guiding the PTFE-based semi-dry electrode film along a serpentine path through the heating chamber with a plurality of rollers positioned within the heating chamber further includes guiding the PTFE-based semi-dry electrode film along a horizontal serpentine pattern through the heating chamber, wherein a primary direction of travel of the PTFE-based semi-dry electrode film is horizontal by supporting the PTFE-based semi-dry electrode film for horizontal movement across the heating chamber with a plurality of horizontal support rollers, and re-directing the horizontal direction of travel of the PTFE-based semi-dry electrode film with a plurality of horizontal transition rollers.

According to another aspect, the supporting the PTFE-based semi-dry electrode film and guiding the PTFE-based semi-dry electrode film along a serpentine path through the heating chamber with a plurality of rollers positioned within the heating chamber further includes guiding the PTFE-based semi-dry electrode film along a vertical serpentine pattern through the heating chamber, wherein a primary direction of travel of the PTFE-based semi-dry electrode film is vertical by supporting the PTFE-based semi-dry electrode film for vertical movement across the heating chamber with a plurality of vertical support rollers, and re-directing the vertical direction of travel of the PTFE-based semi-dry electrode film with a plurality of vertical transition rollers.

According to another aspect, the method further includes collecting, with a solvent recovery system, solvent that has been evaporated from the PTFE-based semi-dry electrode film as the PTFE-based semi-dry electrode film moves through the heating chamber.

According to another aspect, the heating an interior of the heating chamber with at least one heating element further includes maintaining a temperature within the heating chamber of between about one-hundred degrees Celsius and about two-hundred degrees Celsius with the at least one heating element.

According to another aspect, the feeding a PTFE-based semi-dry electrode film through an inlet of a heating chamber further includes supporting, with a supply roll, a length of PTFE-based semi-dry electrode film in proximity to the inlet of the heating chamber, the supporting the PTFE-based semi-dry electrode film and guiding the PTFE-based semi-dry electrode film along a serpentine path through the heating chamber with a plurality of rollers positioned within the heating chamber further includes pulling, with a collector roll, the PTFE-based semi-dry electrode film through the heating chamber from the supply roll, and the removing the PTFE-based semi-dry electrode film from the heating chamber through the outlet further includes collecting, with the collector roll, the dried PTFE-based semi-dry electrode film exiting the heating chamber.

According to another aspect, the pulling, with a collector roll, the PTFE-based semi-dry electrode film through the heating chamber from the supply roll further includes pulling, with the collector roll, the PTFE-based semi-dry electrode film through the heating chamber at a rate of between about fifteen meters per minute and about twenty-five meters per minute.

According to another aspect, the method further includes supporting, with a substrate supply roll, a length of a substrate film in proximity to the inlet of the heating chamber, and positioning, with the supply roll, the PTFE-based semi-dry electrode film onto the substrate film from the substrate supply roll prior to entering the heating chamber through the inlet, wherein the pulling, with a collector roll, the PTFE-based semi-dry electrode film through the heating chamber from the supply roll further includes providing, with the substrate film, tension support as the PTFE-based semi-dry electrode film and the substrate film are pulled through the heating chamber at speeds of about eighty meters per minute, and the removing the PTFE-based semi-dry electrode film from the heating chamber through the outlet further includes separating, with the collector roll, the PTFE-based semi-dry electrode film from the substate film after the PTFE-based semi-dry electrode film and the substrate film exit the heating chamber, and collecting, with a substrate collector roll, the substrate film as the PTFE-based semi-dry electrode film is collected on the collector roll.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for drying PTFE-based semi-dry electrode film by routing the PTFE-based semi-dry electrode film through a heating chamber along a horizontal serpentine pattern;

FIG. 2, is a schematic diagram of a system for drying PTFE-based semi-dry electrode film by routing the PTFE-based semi-dry electrode film through a heating chamber along a vertical serpentine pattern;

FIG. 3 is a schematic diagram of the system shown in FIG. 2, wherein the PTFE-based semi-dry electrode film is supported on a substrate film during drying;

FIG. 4A is a schematic side view of a slurry based electrode film;

FIG. 4B is a schematic side view of the slurry based electrode film shown in FIG. 4A after the electrode film has been dried;

FIG. 5A is a schematic side view of the slurry based electrode film being dried in a vertical orientation;

FIG. 5B is a schematic side view of the slurry based electrode shown in FIG. 5A after the electrode film has been dried;

FIG. 6 is a schematic side view illustrating the drying of a PTFE-based semi-dry electrode film being dried in a horizontal orientation;

FIG. 7 is a schematic side view illustrating the drying of a PTFE-based semi-dry electrode film being dried in a vertical orientation; and

FIG. 8 is a flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of”. Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

Example embodiments will now be described more fully with reference to the accompanying drawings.

An electrochemical cell generally includes a first electrode, such as a positive electrode or cathode, a second electrode such as a negative electrode or an anode, an electrolyte, and a separator. Often, in a lithium-ion battery pack, electrochemical cells are electrically connected in a stack to increase overall output. Lithium-ion electrochemical cells operate by reversibly passing lithium ions between the negative electrode and the positive electrode. The separator and the electrolyte are disposed between the negative and positive electrodes. The electrolyte is suitable for conducting lithium ions and may be in liquid, gel, or solid form. Lithium ions move from a positive electrode to a negative electrode during charging of the battery and in the opposite direction when discharging the battery.

Each of the negative and positive electrodes within a stack is typically electrically connected to a current collector (e.g., a metal, such as copper for the negative electrode and aluminum for the positive electrode). During battery usage, the current collectors associated with the two electrodes are connected by an external circuit that allows current generated by electrons to pass between the negative and positive electrodes to compensate for transport of lithium ions.

Electrodes can generally be incorporated into various commercial battery designs, such as prismatic shaped cells, wound cylindrical cells, coin cells, pouch cells, or other suitable cell shapes. The cells can include a single electrode structure of each polarity or a stacked structure with a plurality of positive electrodes and negative electrodes assembled in parallel and/or series electrical connections. In particular, the battery can include a stack of alternating positive electrodes and negative electrodes with separators disposed therebetween. While the positive electroactive materials can be used in batteries for primary or single charge use, the resulting batteries generally have desirable cycling properties for secondary battery use over multiple cycling of the cells.

With the increasing prevalence of electric vehicles and the global commitment to achieving net zero carbon emissions by 2050, the development of energy storage devices is anticipated to escalate worldwide. Lithium-ion battery (LIB) technology is one of the most promising energy storage technologies due to its lightweight and well-established chemistries. Although LIBs are the ideal candidate that can aid the establishment of renewable green energies via efficient storage, their manufacturing processes are currently energy and resource intensive, typically needing ˜50 kWh of electricity to produce 1 kWh of battery storage. Currently, battery electrodes are manufactured by a wet slurry process wherein active and additive powders are mixed with toxic organic solvents, such as N-methyl-2-pyrrolidone (NMP), which is widely used for cathode manufacture. The NMP solvent is toxic to the environment, and exposure causes severe health hazards to humans. Additionally, the energy and manufacturing space needed for electrode drying and solvent recovery forms a large part of the electrode manufacturing cost (˜78%) during the manufacturing of battery electrodes.

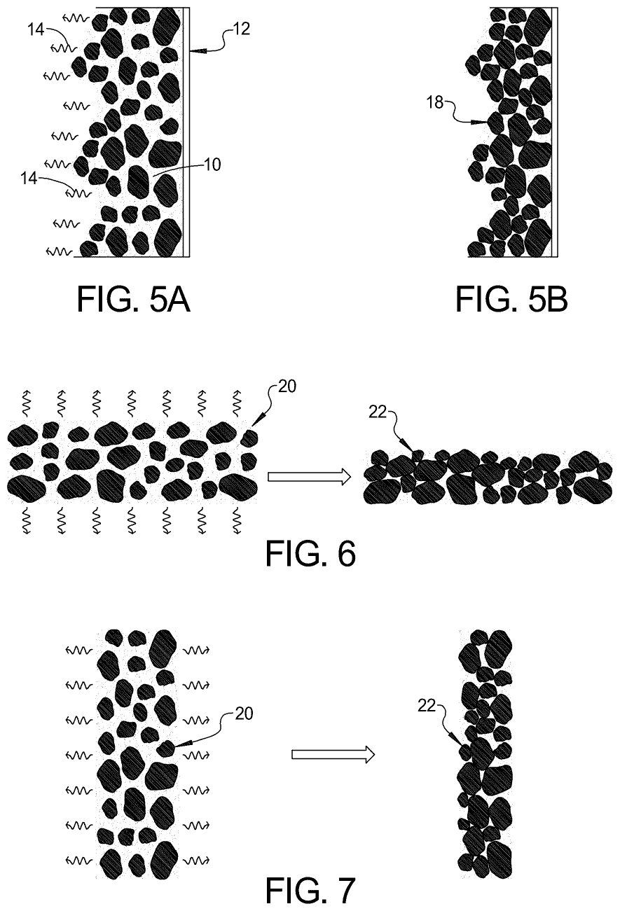

Referring to FIG. 4A, dryers adapted to dry a slurry 10 for a “wet” electrode film 12 must keep the wet electrode film 12 horizontal as the solvents within the slurry 10 evaporate, as indicated at 14, to achieve a flat and even dried electrode film 16, as shown in FIG. 4B. If a wet electrode film 12 is transitioned (change in direction and/or flipped) or dried in a vertical orientation, as shown in FIG. 5A, the slurry 10 of the wet electrode film 12 will flow, resulting in an uneven electrode film 18 with inconsistent thickness, as shown in FIG. 5B. Such dryers must keep the electrode film flat and cannot change direction, and thus, these dryers can be over eighty meters long in order to achieve an eighty meters/minute line speed. These large dryers occupy large amounts of floor space and require large capital equipment investment. Apart from that, the wet slurry process is susceptible to huge variations in the final microstructure of the electrode due to the uncontrollable binder-carbon migration during the solvent evaporation process which results in nonuniform distribution of pores and deteriorates the performance and lifetime of the cell. Thus, there has been a focus on developing dry and semi-dry free-standing electrode film manufacturing processes.

Dry or semi-dry electrode fabrication is a pathway toward sustainable electrode manufacturing that avoids the use of conventional toxic solvents, or at least reduces the amount of solvent used. In general, dry electrode fabrication can be classified into three techniques: electrostatic spray dried (ESD) electrodes, soft template (holey graphene) assisted electrodes, and fibrillation of the binder. The ESD method involves an additional high-voltage source, and scalability of the method is questionable. The holey graphene-assisted electrode has limitations associated with the additional inactive component and requires high pressure for the electrode roll-to-roll fabrication. Thus, the third method is currently the most economically promising and requires only slight adjustments in the current manufacturing lines. By using a fibrillation polymer (e.g., PTFE), the electrode thickness can be tuned without the binder-carbon migration phenomenon which is the main advantage. These PTFE-based dry or semi-dry free-standing electrode films include only between about 5% and about 25% solvent, and are not susceptible to flow of the active material, carbon, binder and solvent, as a slurry is. However, it is still desirable to remove at least some, if not all, of the solvent during the drying process. Thus, referring to FIG. 6, a PTFE-based dry or semi-dry free-standing electrode film 20 can be dried in either a horizontal orientation, resulting in a flat/even electrode film 22, or referring to FIG. 7, the PTFE-based dry or semi-dry free-standing electrode film 20 can be dried in a vertical orientation, resulting in the flat/even electrode film 22. Thus, the PTFE-based dry or semi-dry free-standing electrode film 20 can be dried in either orientation and can withstand transitions (changes in direction and/or flipped). Moreover, thick dry electrodes can reduce the pack size and increase the overall energy density of the pack, favoring practical applications.

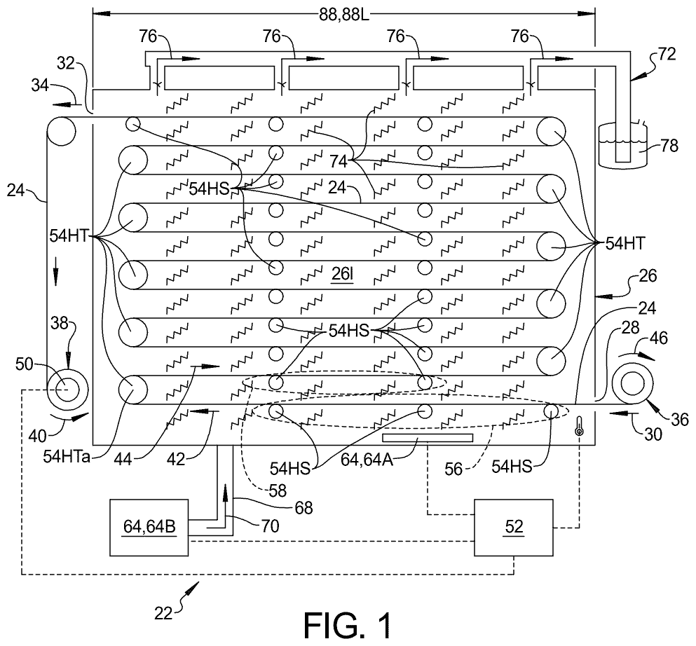

Referring to FIG. 1, a system 22 for drying polytetrafluoroethylene (PTFE) based semi-dry electrode film 24 includes a heating chamber 26 having an inlet 28 adapted to receive a PTFE-based semi-dry electrode film 24 into the heating chamber 26, as indicated by arrow 30, and an outlet 32 adapted to allow the PTFE-based semi-dry electrode film 24 to exit the heating chamber 26, as indicated by arrow 34.

In an exemplary embodiment, and as shown in FIG. 1, the system 22 includes a supply roll 36 adapted to support a length of PTFE-based semi-dry electrode film 24 thereon. The PTFE-based semi-dry electrode film 24 may be created by any process or mechanism known or developed in the future for manufacturing such electrode films. The PTFE-based semi-dry electrode film 24 may be created on site, near the system 22 of the present disclosure, and fed directly to the system 22, or may be created remotely and stored/transported on a supply roll 36. The supply roll 36 is positioned in proximity to the inlet 28 of the heating chamber 26 to allow the PTFE-based semi-dry electrode film 24 to be fed into the heating chamber 26 through the inlet 28.

Further, in the exemplary embodiment shown in FIG. 1, the system 22 includes a collector roll 38 adapted to pull the PTFE-based semi-dry electrode film 24 through the heating chamber 26 from the supply roll 36 and to collect the dried PTFE-based semi-dry electrode film 24 exiting the heating chamber 26 through the outlet 32. In an exemplary embodiment, the collector roll 38 is motor driven, such that when a length of PTFE-based semi-dry electrode film 24 is fed into the heating chamber 26 through the inlet 28 and routed through the heating chamber 26 to the outlet 32, the PTFE-based semi-dry electrode film 24 exits the heating chamber 26, wherein an end of the PTFE-based semi-dry electrode film 24 is attached to the collector roll 38. Thus, when the motor driven collector roll 38 rotates, as shown by arrow 40, the PTFE-based semi-dry electrode film 24 is pulled through the heating chamber 26, as indicated by arrows 30, 34, 42, 44, and pulled from the supply roll 36, as indicated by arrow 46. In still another exemplary embodiment, the supply roll 36 is clutched to provide some resistance to rotation, wherein when the collector roll 38 pulls the PTFE-based semi-dry electrode film 24 from the supply roll 36, a level of tension is maintained on the PTFE-based semi-dry electrode film 24, preventing any slack within the heating chamber 26, and preventing the supply roll 36 from free-wheeling or over-rotating (rotating faster than the collector roll 38).

In still another exemplary embodiment, the collector roll 38 is adapted to pull the PTFE-based semi-dry electrode film 24 through the heating chamber 26 at a rate of between about fifteen meters per minute and about twenty-five meters per minute. The free-standing PTFE-based semi-dry electrode film 24 can withstand the tension placed upon it when pulled at this rate. In other embodiments, the collector roll 38 is adapted to pull the PTFE-based semi-dry electrode film 24 at faster rates, but in such embodiments, a substrate film 48 is needed to provide tension support for the PTFE-based semi-dry electrode film 24, as will be discussed below.

The motor drive 50 of the collector roll 38 is in communication with a system controller 52 adapted to control the collector roll 38 and the rate at which the collector roll 38 pulls the PTFE-based semi-dry electrode film 24 through the heating chamber 26. The system controller 52 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

The system 22 further includes a plurality of rollers 54 positioned within the heating chamber 26 and adapted to support the PTFE-based semi-dry electrode film 24 and guide the PTFE-based semi-dry electrode film 24 along a serpentine path through the heating chamber 26 between the inlet 28 and the outlet 32 as the PTFE-based semi-dry electrode film 24 is pulled through the heating chamber 26.

As shown in FIG. 1, in an exemplary embodiment, the plurality of rollers 54 are arranged within the heating chamber 26 and adapted to guide the PTFE-based semi-dry electrode film 24 along a horizontal serpentine pattern through the heating chamber 26, wherein a primary direction of travel of the PTFE-based semi-dry electrode film 24 is horizontal. The plurality of rollers 54 within the heating chamber 26 include a plurality of horizontal support rollers 54HS adapted to support the PTFE-based semi-dry electrode film 24 for horizontal movement across the heating chamber 26, and a plurality of horizontal transition rollers 54HT adapted to re-direct the horizontal direction of travel of the PTFE-based semi-dry electrode film 24.

Thus, the PTFE-based semi-dry electrode film 24 travels through the heating chamber 26, horizontally (moving to the left, arrow 42) across a first row 56 of horizontal support rollers 54HS, and upon reaching a first horizontal transition roller 54HTa, transitions upward around the first horizontal transition roller 54HTa and continues horizontally (moving to the right, arrow 44) across a second row 58 of horizontal support rollers 54HT. The PTFE-based semi-dry electrode film 24 travels in this manner, repeatedly moving left or right horizontally across the heating chamber 26, transitioning at horizontal transition rollers 54HT, in a serpentine pattern until reaching the outlet 32 of the heating chamber 26.

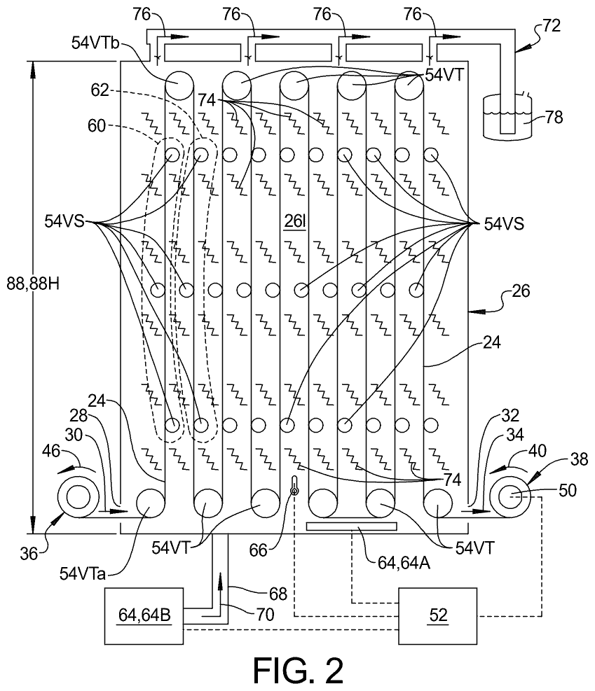

Referring to FIG. 2, in an exemplary embodiment, the plurality of rollers 54 are arranged within the heating chamber 26 and adapted to guide the PTFE-based semi-dry electrode film 24 along a vertical serpentine pattern through the heating chamber 26, wherein a primary direction of travel of the PTFE-based semi-dry electrode film 24 is vertical. The plurality of rollers 54 within the heating chamber 26 include a plurality of vertical support rollers 54VS adapted to support the PTFE-based semi-dry electrode film 24 for vertical movement across the heating chamber 26, and a plurality of vertical transition rollers 54VT adapted to re-direct the vertical direction of travel of the PTFE-based semi-dry electrode film 24.

Thus, as shown, the PTFE-based semi-dry electrode film 24 enters the heating chamber 26 through the inlet 28 to a first vertical transition roller 54VTa, that redirects the PTFE-based semi-dry electrode film 24 upward, wherein the PTFE-based semi-dry electrode film 24 travels through the heating chamber 26, vertically (moving upward) across a within first row 60 of vertical support rollers 54VS.

The vertical support rollers 54VS within the first row 60 are alternately positioned on opposite sides of the vertically oriented PTFE-based semi-dry electrode film 24 to provide stability and keep the PTFE-based semi-dry electrode film 24 from bouncing or swinging sideways, left and right. Upon reaching a second vertical transition roller 54VTb, the PTFE-based semi-dry electrode film 24 transitions downward around the second vertical transition roller 54VTb and continues vertically (moving downward) across and within a second row 62 of vertical support rollers 54VS. The vertical support rollers 54VS within the second row 62, like the first row 60, and all rows thereafter, are alternately positioned on opposite sides of the vertically oriented PTFE-based semi-dry electrode film 24 to provide stability and keep the PTFE-based semi-dry electrode film 24 from bouncing or swinging sideways, left and right. The PTFE-based semi-dry electrode film 24 travels in this manner, repeatedly moving upward or downward vertically across the heating chamber, transitioning at vertical transition rollers 54VT, in a serpentine pattern until reaching the outlet 32 of the heating chamber 26.

The heating chamber 26 further includes at least one heating element 64 adapted to heat an interior 26I of the heating chamber 26. The heating chamber 26 is adapted to remove, by evaporation, at least a portion of solvent that is present within the PTFE-based semi-dry electrode film 24 that enters the heating chamber 26. To enable evaporation of the solvent, the interior 26I of the heating chamber 26 is heated to accelerate evaporation of the solvent. The temperature within the interior 26I of the heating chamber 26 may be between twenty-five degrees Celsius and two-hundred fifty degrees Celsius. In an exemplary embodiment, the at least one heating element 64 is adapted to maintain a temperature within the heating chamber 26 of between about one-hundred degrees Celsius and about two-hundred degrees Celsius. It should be understood that the interior temperature of the heating chamber 26 is adapted to be maintained at a target temperature that is dependent upon the materials and solvent used in the PTFE-based semi-dry electrode film 24, thermodynamic characteristics of the heating chamber 26 and line speed targets for the system 22. In an exemplary embodiment, the system controller 52 is in communication with a temperature sensor 66 within the heating chamber 26 and the at least one heating element 64, whereby the system controller 52 receives data from the temperature sensor 66 to monitor the temperature of the interior 26I of the heating chamber 26, and controls the operation of the at least one heating element 64 to maintain the temperature within the heating chamber 26 at a target temperature or within a target temperature range.

As shown in FIG. 1 and in FIG. 2, the at least one heating element 64 may be an internal heating element 64A positioned within the heating chamber 26. Alternatively, the at least one heating element 64 may be an external heating element 64B positioned outside of the heating chamber 26 and adapted to feed heated air to the interior 26I of the heating chamber 26 through ductwork 68, as indicated by arrow 70.

In an exemplary embodiment, the heating element 64 is adapted to at least one of 1) heat the interior 26I of the heating chamber 26 using one of forced convention or natural convection, 2) heat the interior 26I of the heating chamber 26 with force air, and 3) heat the interior 26I of the heating chamber 26 using infrared radiation.

A forced convection heating element 64A, 64B uses a fan or turbine to circulate the air inside the heating chamber 26. This promotes uniform heat distribution and accelerates the drying process. A natural convection heating element 64A, 64B utilizes thermal energy entering the heating chamber 26 naturally, as temperatures rises, the air dries the PTFE-based semi-dry electrode film 24 more quickly.

Forced air heating takes the air from inside of the heating chamber 26 and passes it over a heating element to warm it up, and then recirculates it throughout the interior of the heating chamber 26. When the air is recirculated, it passes back over the heating element again and again until the ambient temperature of the heating chamber 26 gets to the desired level. A force air heating element 64B would generally be positioned outside the heating chamber 26 and comprise a gas or electric furnace or heat pump. Heat sources for a forced air system may include electric heating elements that warm up when electricity passes through them, a heat pump that uses electricity to transfer heat from the outside air (even in cold weather) and circulate it inside, or combustion of a fuel such as natural gas, propane, or heating oil.

An infrared heating element 64A, 64B works by emitting infrared radiation. Infrared heating uses a heating element made of materials like quartz, ceramic, or metal. When an electric current passes through this element, it generates heat. The heating element then emits infrared radiation, which is a form of invisible light. Unlike visible light, which we can see, infrared light falls beyond the spectrum of our eyes. This emitted infrared radiation directly transfers heat to objects in its path. Whatever is near an infrared heater, absorbs this light and is warmed by it.

In an exemplary embodiment, the system 22 further includes a solvent recovery system 72 adapted to collect solvent that has been evaporated from the PTFE-based semi-dry electrode film 24 as the PTFE-based semi-dry electrode film 24 moves through the heating chamber 26. Liquid solvent evaporates from the PTFE-based semi-dry electrode film 24 as indicated at 74. Thus, the interior 26I of the heating chamber 26 becomes occupied by gaseous solvent. The solvent recovery system 72 pulls gaseous solvent from the interior 26I of the heating chamber 26, as indicated by arrows 76, and collects it in a reservoir 78. In some embodiments, the solvent recovery system 72 is adapted to filter impurities out of the captured vapors, separating the solvent and then condensing the solvent back to liquid form for collection, storage and potential re-use.

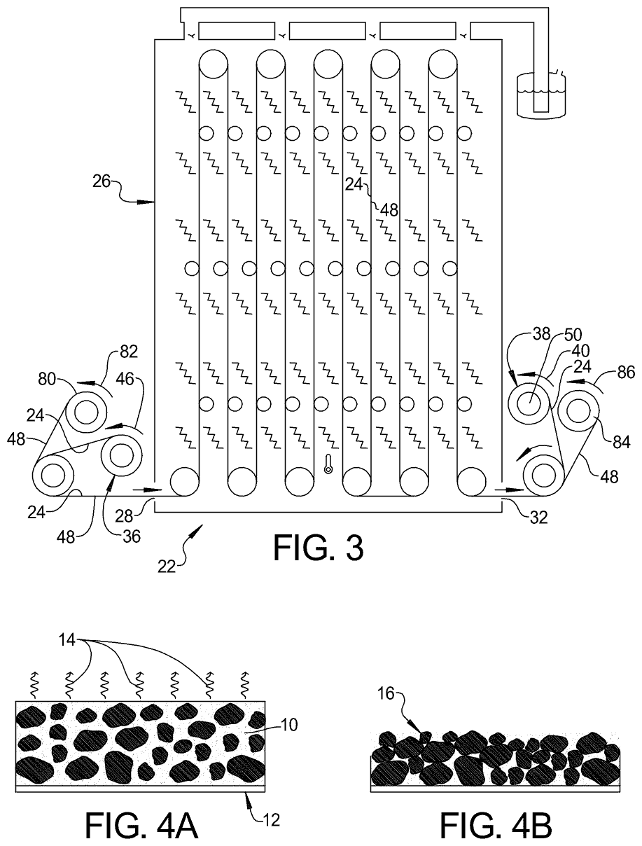

As mentioned above, in some instances it may be desirable to pull the PTFE-based semi-dry electrode film 24 through the heating chamber 26 at rates much faster than fifteen to twenty-five meters per minute. Referring to FIG. 3, in an exemplary embodiment, the system 22 further includes a substrate supply roll 80 adapted to support a length of a substate film 48 thereon. The substrate supply roll 80 is positioned in proximity to the inlet 28 of the heating chamber 26 and to the supply roll 36, wherein the system 22 is adapted to position the PTFE-based semi-dry electrode film 24 pulled from the supply roll 36, as indicated by arrow 46, onto the substrate film 48 pulled from the substrate supply roll 80, as indicated by arrow 82, prior to entering the heating chamber 26 through the inlet 28. The PTFE-based semi-dry electrode film 24 and the substrate film 48 move in unison through the heating chamber 26 and the substrate film 48 is adapted to provide tension support as the PTFE-based semi-dry electrode film 24 and the substrate film 48 are pulled through the heating chamber 26 at speeds of about eighty meters per minute.

In an exemplary embodiment, the substrate film 48 comprises one of polyethylene terephthalate (PET), stainless steel mesh, copper mesh, or aluminum mesh. Without the substrate film 48 the tension placed on the PTFE-based semi-dry electrode film 24 would break the film. The substrate film 48 provides support to allow the PTFE-based semi-dry electrode film 24 to be pulled through the heating chamber 26 at faster rates, thus increasing the line speed and product output of the system 22.

The system 22 further includes a substrate collector roll 84 adapted to collect the substrate film 48 exiting the heating chamber 26. The substrate collector roll 84 is positioned in proximity to the outlet 32 of the heating chamber 26 and in proximity to the collector roll 38 as will be explained below. As the PTFE-based semi-dry electrode film 24 exits the heating chamber 26, supported on the substrate film 48, the collector roll 38 pulls the PTFE-based semi-dry electrode film 24 from the substrate film 48, as indicated by arrow 40. The substrate film 48 is being collected on the substrate collector roll 84, as indicated by arrow 86, and is pulled in a different direction, thus, the collector roll 38 and the substrate collector roll 84 pull the PTFE-based semi-dry electrode film 24 and the substrate film 48 apart, separating the PTFE-based semi-dry electrode film 24 from the substate film 48 after the PTFE-based semi-dry electrode film 24 and the substrate film 48 exit the heating chamber 26. The PTFE-based semi-dry electrode film 24 is collected on the collector roll 38, as indicated by arrow 40, and the substrate film 48 is collected on the substrate collector roll 84, as indicated by arrow 86.

As mentioned above, it is advantageous to run at a relatively high line speed, increasing product output, etc. Prior art systems require long single layer dryers which take up space and are expensive. The heating chamber 26 of the present disclosure takes advantage of the fact that free-standing PTFE-based semi-dry electrode film 24 is capable of drying in a horizontal or a vertical orientation and is capable of changing direction and/or being flipped, routed through the heating chamber 26 in a serpentine pattern, thus maximizing the length of PTFE-based semi-dry electrode film 24 that is within the heating chamber 26 and minimizing the overall dimensions of the heating chamber 26.

In an exemplary embodiment, the heating chamber 26 has a dimension 88, measured along the primary direction of travel of the PTFE-based semi-dry electrode film 24, that is between about five meters and about seven meters, wherein, the serpentine path through the heating chamber 26 has a length that is about ten times the dimension 88 of the heating chamber 26 measured along the primary direction of travel of the PTFE-based semi-dry electrode film 24. In other embodiments the heating chamber 26 has a dimension 88, measured along the primary direction of travel of the PTFE-based semi-dry electrode film 24, that is between about three meters and about ten meters

Referring again to FIG. 1, the heating chamber 26 provides a horizontal primary direction of travel, and the heating chamber 26 has a dimension 88, measured along the primary direction of travel (length 88L). Wherein, if the length 88L of the heating chamber 26 is seven meters, then the plurality of rollers 54 within the heating chamber 26 includes enough rows of horizontal support rollers 54HS and horizontal transition rollers 54HT to accommodate a length of PTFE-based semi-dry electrode film 24 that is at least ten times the length 88L of the heating chamber, or at least seventy meters.

Referring again to FIG. 2, the heating chamber 26 provides a vertical primary direction of travel, and the heating chamber 26 has a dimension 88, measured along the primary direction of travel (height 88H). Wherein, if the height 88H of the heating chamber 26 is seven meters, then the plurality of rollers 54 within the heating chamber 26 includes enough rows of vertical support rollers 54VS and vertical transition rollers 54VT to accommodate a length of PTFE-based semi-dry electrode film 24 that is at least ten times the height 88H of the heating chamber 26, or at least seventy meters.

Thus, for the example of FIG. 1 or FIG. 2, if the target line speed is seventy meters per minute, a discreet point on the PTFE-based semi-dry electrode film 24 spends approximately one minute within the heating chamber 26. Based on the chemistry of the PTFE-based semi-dry electrode film 24, and thermodynamic properties of the heating chamber 26, the rate that the PTFE-based semi-dry electrode film 24 moves through the heating chamber 26 can be controlled by the system controller 52 to ensure the PTFE-based semi-dry electrode film 24 meets target specifications for removal of solvent. If required line speeds dictate, a substrate film 48 can be used to provide needed additional support. Additionally, multiple heating chambers 26 may be positioned in series to provide more drying time at reduced line speeds.

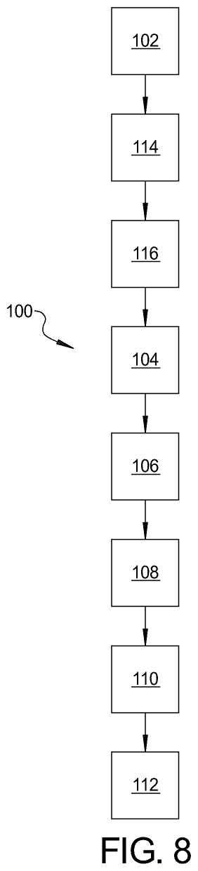

Referring to FIG. 8, a method 100 for drying polytetrafluoroethylene (PTFE) based semi-dry electrode film 24 includes, starting at block 102, feeding a PTFE-based semi-dry electrode film 24 through an inlet 28 of a heating chamber 26, moving to block 104, heating an interior 261 of the heating chamber 26 with at least one heating element 64, moving to block 106, supporting the PTFE-based semi-dry electrode film 24 and guiding the PTFE-based semi-dry electrode film 24 along a serpentine path through the heating chamber 26 with a plurality of rollers 54 positioned within the heating chamber 26 between the inlet 28 and an outlet 32 as the PTFE-based semi-dry electrode film 24 is pulled through the heating chamber 26, moving to block 108, removing, by evaporation, at least a portion of solvent that is present within the PTFE-based semi-dry electrode film 24 that enters the heating chamber 26, and, moving to block 110, removing the PTFE-based semi-dry electrode film 24 from the heating chamber 26 through the outlet 32.

In an exemplary embodiment, the supporting the PTFE-based semi-dry electrode film and guiding the PTFE-based semi-dry electrode film 24 along a serpentine path through the heating chamber 26 with a plurality of rollers 54 positioned within the heating chamber 26 at block 106 further includes guiding the PTFE-based semi-dry electrode film 24 along a horizontal serpentine pattern through the heating chamber 26, wherein a primary direction of travel of the PTFE-based semi-dry electrode film 24 is horizontal by supporting the PTFE-based semi-dry electrode film 24 for horizontal movement across the heating chamber 26 with a plurality of horizontal support rollers 54HS, and re-directing the horizontal direction of travel of the PTFE-based semi-dry electrode film 24 with a plurality of horizontal transition rollers 54HT.

In another exemplary embodiment, the supporting the PTFE-based semi-dry electrode film 24 and guiding the PTFE-based semi-dry electrode film 24 along a serpentine path through the heating chamber 26 with a plurality of rollers 54 positioned within the heating chamber 26 at block 106 further includes guiding the PTFE-based semi-dry electrode film 24 along a vertical serpentine pattern through the heating chamber 26, wherein a primary direction of travel of the PTFE-based semi-dry electrode film is vertical, by supporting the PTFE-based semi-dry electrode film 24 for vertical movement across the heating chamber 26 with a plurality of vertical support rollers 54VS, and re-directing the vertical direction of travel of the PTFE-based semi-dry electrode film 24 with a plurality of vertical transition rollers 54VT.

In another exemplary embodiment, the method 100 further includes, moving to block 112, collecting, with a solvent recovery system 72, solvent that has been evaporated from the PTFE-based semi-dry electrode film 24 as the PTFE-based semi-dry electrode film 24 moves through the heating chamber 26.

In another exemplary embodiment, the heating an interior 26I of the heating chamber 26 with at least one heating element 64 at block 104 further includes maintaining a temperature within the heating chamber 26 of between about one-hundred degrees Celsius and about two-hundred degrees Celsius with the at least one heating element 64.

In another exemplary embodiment, the feeding a PTFE-based semi-dry electrode film 24 through an inlet 28 of a heating chamber 26 at block 102 further includes supporting, with a supply roll 36, a length of PTFE-based semi-dry electrode film 24 in proximity to the inlet 28 of the heating chamber 26, the supporting the PTFE-based semi-dry electrode film 24 and guiding the PTFE-based semi-dry electrode film 24 along a serpentine path through the heating chamber 26 with a plurality of rollers 54 positioned within the heating chamber 26 at block 106 further includes pulling, with a collector roll 38, the PTFE-based semi-dry electrode film 24 through the heating chamber 26 from the supply roll 36, and the removing the PTFE-based semi-dry electrode film 24 from the heating chamber 26 through the outlet 32 at block 108 further includes collecting, with the collector roll 38, the dried PTFE-based semi-dry electrode film 24 exiting the heating chamber 26.

In another exemplary embodiment, the pulling, with a collector roll 38, the PTFE-based semi-dry electrode film 24 through the heating chamber 26 from the supply roll 36 at block 110 further includes pulling, with the collector roll 38, the PTFE-based semi-dry electrode film 24 through the heating chamber 26 at a rate of between about fifteen meters per minute and about twenty-five meters per minute.

In still another exemplary embodiment, the method 100 further includes, moving from block 102 to block 114, supporting, with a substrate supply roll 80, a length of a substrate film 48 in proximity to the inlet 28 of the heating chamber 26, and, moving to block 116, positioning, with the supply roll 36, the PTFE-based semi-dry electrode film 24 onto the substrate film 48 from the substrate supply roll 80 prior to entering the heating chamber 26 through the inlet 28, wherein, the pulling, with a collector roll 38, the PTFE-based semi-dry electrode film 24 through the heating chamber 26 from the supply roll 36 at block 110 further includes providing, with the substrate film 48, tension support as the PTFE-based semi-dry electrode film 24 and the substrate film 48 are pulled through the heating chamber 26 at speeds of about eighty meters per minute, and, the removing the PTFE-based semi-dry electrode film 24 from the heating chamber 26 through the outlet 32 at block 110 further includes separating, with the collector roll 38, the PTFE-based semi-dry electrode film 24 from the substate film 48 after the PTFE-based semi-dry electrode film 24 and the substrate film 48 exit the heating chamber 26, and collecting, with a substrate collector roll 84, the substrate film 48 as the PTFE-based semi-dry electrode film 24 is collected on the collector roll 38.

A system 22 and method 100 of the present disclosure offers several advantages. These include taking advantage of the fact that free-standing PTFE-based semi-dry electrode film 24 is capable of drying in a horizontal or a vertical orientation and is capable of changing direction and/or being flipped, to route the PTFE-based semi-dry electrode film 24 through a heating chamber 26 in a serpentine pattern, thus maximizing the length of PTFE-based semi-dry electrode film 24 that is within the heating chamber 26 and minimizing the overall dimensions of the heating chamber 26, thus reducing space required to dry the PTFE-based semi-dry electrode film 24, reducing costs associated with drying the PTFE-based semi-dry electrode film 24, and increasing production rates.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for drying polytetrafluoroethylene (PTFE) based semi-dry electrode film, comprising:
a heating chamber including:
an inlet adapted to receive a PTFE-based semi-dry electrode film into the heating chamber;
an outlet adapted to allow the PTFE-based semi-dry electrode film to exit the heating chamber;
a plurality of rollers positioned within the heating chamber and adapted to support the PTFE-based semi-dry electrode film and guide the PTFE-based semi-dry electrode film along a serpentine path through the heating chamber between the inlet and the outlet as the PTFE-based semi-dry electrode film is pulled through the heating chamber; and
at least one heating element adapted to heat an interior of the heating chamber;
wherein, the heating chamber is adapted to remove, by evaporation, at least a portion of solvent that is present within the PTFE-based semi-dry electrode film that enters the heating chamber.

2. The system of claim 1, wherein the plurality of rollers are arranged within the heating chamber and adapted to guide the PTFE-based semi-dry electrode film along a horizontal serpentine pattern through the heating chamber, wherein a primary direction of travel of the PTFE-based semi-dry electrode film is horizontal, the plurality of rollers within the heating chamber including:
a plurality of horizontal support rollers adapted to support the PTFE-based semi-dry electrode film for horizontal movement across the heating chamber; and
a plurality of horizontal transition rollers adapted to re-direct the horizontal direction of travel of the PTFE-based semi-dry electrode film.

3. The system of claim 1, wherein the plurality of rollers are arranged within the heating chamber and adapted to guide the PTFE-based semi-dry electrode film along a vertical serpentine pattern through the heating chamber, wherein a primary direction of travel of the PTFE-based semi-dry electrode film is vertical, the plurality of rollers within the heating chamber including:
a plurality of vertical support rollers adapted to support the PTFE-based semi-dry electrode film for vertical movement across the heating chamber; and
a plurality of vertical transition rollers adapted to re-direct the vertical direction of travel of the PTFE-based semi-dry electrode film.

4. The system of claim 1, further including a solvent recovery system adapted to collect solvent that has been evaporated from the PTFE-based semi-dry electrode film as the PTFE-based semi-dry electrode film moves through the heating chamber.

5. The system of claim 4, wherein the at least one heating element is adapted to maintain a temperature within the heating chamber of between about one-hundred degrees Celsius and about two-hundred degrees Celsius.

6. The system of claim 5, wherein the heating element is adapted to at least one of:
heat the interior of the heating chamber using one of forced convention or natural convection;
heat the interior of the heating chamber with forced air; and
heat the interior of the heating chamber using infrared radiation.

7. The system of claim 6, further including:
a supply roll adapted to support a length of PTFE-based semi-dry electrode film thereon, the supply roll positioned in proximity to the inlet of the heating chamber; and
a collector roll adapted to pull the PTFE-based semi-dry electrode film through the heating chamber from the supply roll and to collect the dried PTFE-based semi-dry electrode film exiting the heating chamber.

8. The system of claim 7, wherein the collector roll is adapted to pull the PTFE-based semi-dry electrode film through the heating chamber at a rate of between about fifteen meters per minute and about twenty-five meters per minute.

9. The system of claim 7, further including:
a substrate supply roll adapted to support a length of a substate film thereon, the substrate supply roll positioned in proximity to the inlet of the heating chamber; and
a substrate collector roll adapted to collect the substrate film exiting the heating chamber;
wherein, the system is adapted to:
position the PTFE-based semi-dry electrode film from the supply roll onto the substrate film from the substrate supply roll prior to entering the heating chamber through the inlet, the substrate film adapted to provide tension support as the PTFE-based semi-dry electrode film and the substrate film are pulled through the heating chamber at speeds of about eighty meters per minute; and
separate the PTFE-based semi-dry electrode film from the substate film after the PTFE-based semi-dry electrode film and the substrate film exit the heating chamber, wherein, the PTFE-based semi-dry electrode film is collected on the collector roll and the substrate film is collected on the substrate collector roll.

10. The system of claim 9, wherein the substrate film comprises one of polyethylene terephthalate (PET), stainless steel mesh, copper mesh, or aluminum mesh.

11. The system of claim 7, wherein the heating chamber has a dimension, measured along the primary direction of travel of the PTFE-based semi-dry electrode film, that is between about five meters and about 7 meters, wherein, the serpentine path through the heating chamber has a length that is about ten times the dimension of the heating chamber measured along the primary direction of travel of the PTFE-based semi-dry electrode film.

12. A method for drying polytetrafluoroethylene (PTFE) based semi-dry electrode film, comprising:
feeding a PTFE-based semi-dry electrode film through an inlet of a heating chamber;
heating an interior of the heating chamber with at least one heating element;
supporting the PTFE-based semi-dry electrode film and guiding the PTFE-based semi-dry electrode film along a serpentine path through the heating chamber with a plurality of rollers positioned within the heating chamber between the inlet and an outlet as the PTFE-based semi-dry electrode film is pulled through the heating chamber;
removing, by evaporation, at least a portion of solvent that is present within the PTFE-based semi-dry electrode film that enters the heating chamber; and
removing the PTFE-based semi-dry electrode film from the heating chamber through the outlet.

13. The method of claim 12, wherein the supporting the PTFE-based semi-dry electrode film and guiding the PTFE-based semi-dry electrode film along a serpentine path through the heating chamber with a plurality of rollers positioned within the heating chamber further includes guiding the PTFE-based semi-dry electrode film along a horizontal serpentine pattern through the heating chamber, wherein a primary direction of travel of the PTFE-based semi-dry electrode film is horizontal by:
supporting the PTFE-based semi-dry electrode film for horizontal movement across the heating chamber with a plurality of horizontal support rollers; and
re-directing the horizontal direction of travel of the PTFE-based semi-dry electrode film with a plurality of horizontal transition rollers.

14. The method of claim 12, wherein the supporting the PTFE-based semi-dry electrode film and guiding the PTFE-based semi-dry electrode film along a serpentine path through the heating chamber with a plurality of rollers positioned within the heating chamber further includes guiding the PTFE-based semi-dry electrode film along a vertical serpentine pattern through the heating chamber, wherein a primary direction of travel of the PTFE-based semi-dry electrode film is vertical by:
supporting the PTFE-based semi-dry electrode film for vertical movement across the heating chamber with a plurality of vertical support rollers; and
re-directing the vertical direction of travel of the PTFE-based semi-dry electrode film with a plurality of vertical transition rollers.

15. The method of claim 12, further including collecting, with a solvent recovery system, solvent that has been evaporated from the PTFE-based semi-dry electrode film as the PTFE-based semi-dry electrode film moves through the heating chamber.

16. The method of claim 15, wherein the heating an interior of the heating chamber with at least one heating element further includes maintaining a temperature within the heating chamber of between about one-hundred degrees Celsius and about two-hundred degrees Celsius with the at least one heating element.

17. The method of claim 16, wherein:
the feeding a PTFE-based semi-dry electrode film through an inlet of a heating chamber further includes supporting, with a supply roll, a length of PTFE-based semi-dry electrode film in proximity to the inlet of the heating chamber;
the supporting the PTFE-based semi-dry electrode film and guiding the PTFE-based semi-dry electrode film along a serpentine path through the heating chamber with a plurality of rollers positioned within the heating chamber further includes pulling, with a collector roll, the PTFE-based semi-dry electrode film through the heating chamber from the supply roll; and
the removing the PTFE-based semi-dry electrode film from the heating chamber through the outlet further includes collecting, with the collector roll, the dried PTFE-based semi-dry electrode film exiting the heating chamber.

18. The method of claim 17, wherein the pulling, with a collector roll, the PTFE-based semi-dry electrode film through the heating chamber from the supply roll further includes pulling, with the collector roll, the PTFE-based semi-dry electrode film through the heating chamber at a rate of between about fifteen meters per minute and about twenty-five meters per minute.

19. The method of claim 17, further including:
supporting, with a substrate supply roll, a length of a substrate film in proximity to the inlet of the heating chamber; and
positioning, with the supply roll, the PTFE-based semi-dry electrode film onto the substrate film from the substrate supply roll prior to entering the heating chamber through the inlet;
wherein the pulling, with a collector roll, the PTFE-based semi-dry electrode film through the heating chamber from the supply roll further includes providing, with the substrate film, tension support as the PTFE-based semi-dry electrode film and the substrate film are pulled through the heating chamber at speeds of about eighty meters per minute; and
the removing the PTFE-based semi-dry electrode film from the heating chamber through the outlet further includes:
separating, with the collector roll, the PTFE-based semi-dry electrode film from the substate film after the PTFE-based semi-dry electrode film and the substrate film exit the heating chamber; and
collecting, with a substrate collector roll, the substrate film as the PTFE-based semi-dry electrode film is collected on the collector roll.

20. A system for drying polytetrafluoroethylene (PTFE) based semi-dry electrode film, comprising:
a heating chamber including:
an inlet adapted to receive a PTFE-based semi-dry electrode film into the heating chamber;
a supply roll adapted to support a length of PTFE-based semi-dry electrode film thereon, the supply roll positioned in proximity to the inlet of the heating chamber;
an outlet adapted to allow the PTFE-based semi-dry electrode film to exit the heating chamber;
a collector roll adapted to pull the PTFE-based semi-dry electrode film through the heating chamber from the supply roll and to collect the dried PTFE-based semi-dry electrode film exiting the heating chamber through the outlet;
a substrate supply roll adapted to support a length of a substrate film thereon, the substrate film comprising one of polyethylene terephthalate (PET), stainless steel mesh, copper mesh, or aluminum mesh, the substrate supply roll positioned in proximity to the inlet of the heating chamber;
a substrate collector roll adapted to collect the substrate film exiting the heating chamber;
wherein, the system is adapted to:
position the PTFE-based semi-dry electrode film from the supply roll onto the substrate film from the substrate supply roll prior to entering the heating chamber through the inlet, the substrate film adapted to provide tension support as the PTFE-based semi-dry electrode film and the substrate film are pulled through the heating chamber; and
separate the PTFE-based semi-dry electrode film from the substate film after the PTFE-based semi-dry electrode film and the substrate film exit the heating chamber, wherein, the PTFE-based semi-dry electrode film is collected on the collector roll and the substrate film is collected on the substrate collector roll;
a plurality of rollers positioned within the heating chamber and adapted to support the PTFE-based semi-dry electrode film and guide the PTFE-based semi-dry electrode film along a serpentine path through the heating chamber between the inlet and the outlet as the PTFE-based semi-dry electrode film is pulled through the heating chamber;
at least one heating element adapted to heat an interior of the heating chamber and maintain a temperature within the heating chamber of between about one-hundred degrees Celsius and about two-hundred degrees Celsius and remove, by evaporation, at least a portion of solvent that is present within the PTFE-based semi-dry electrode film that enters the heating chamber; and
a solvent recovery system adapted to collect solvent that has been evaporated from the PTFE-based semi-dry electrode film as the PTFE-based semi-dry electrode film moves through the heating chamber.
